(19) United States
(12) Patent Application Publication
(10) Pub. No.: US 2026/0237693 A1
(43) Pub. Date: Aug. 13, 2026

(54) HYDROGEN HEAT EXCHANGER SYSTEMS AND METHODS FOR FUEL CELLS

(71) Applicant: ZeroAvia Ltd, Cirencester (GB)

(72) Inventors: Matthew Legg, Cirencester (GB); James Holt, Cirencester (GB)

(21) Appl. No.: 19/464,154

(22) Filed: Jan. 29, 2026

(30) Foreign Application Priority Data
Jan. 29, 2025 (GB) 2501270.9

(51) Int. Cl. H01M 8/04029; B60L 50/71; H01M 8/04014; H01M 8/04082

(52) U.S. Cl. CPC H01M 8/04029; B60L 50/71; H01M 8/04014; H01M 8/04201; B60L 2200/10; H01M 2250/20

(57) ABSTRACT

Systems and methods for exchanging heat in a heat exchanger (HE) of a fuel cell (FC) powered vehicle, such as a hydrogen-powered aircraft, include an inner pipe or tube which is configured for receiving a fluid and at least one spiral path positioned around the inner pipe and an outer tube or jacket surrounding the inner tube at least in part. The at least one spiral path is configured to receive a fluid at an inlet of the spiral path. The fluid is movable along a length of the at least one spiral path, and thermal energy of the fluid within the inner pipe is transferrable between the fluid within the inner pipe and the fluid in the at least one spiral path.

### FIELD OF THE DISCLOSURE

The present disclosure relates to hydrogen (H2) preconditioning for an H2 fuel cell (FC). The disclosure has particular utility with H2 heat exchanger systems (HEs) for preconditioning H2 for FCs used in H2 FC-powered vehicles such as aircraft, and will be described in connection with such utility, although other utilities are contemplated.

### Background and Summary

This section provides background information related to the present disclosure which is not necessarily prior art. This section provides a general summary of the disclosure and is not a comprehensive disclosure of its full scope or all its features.

An H2 FC is an electrochemical cell that converts chemical energy into electrical energy by spontaneous electrochemical reduction-oxidation (redox) reactions. FCs include an anode and a cathode separated by an ionically conductive electrolyte. During operation, gaseous H2 fuel is supplied to the anode and an oxidant (e.g., oxygen or air) is supplied to the cathode. The H2 fuel is oxidized at the anode, producing positively charged ions (e.g., H2 ions) and electrons. The positively charged ions travel through the electrolyte from the anode to the cathode, while the electrons simultaneously travel from the anode to the cathode outside the cell via an external circuit, which produces an electric current. The oxidant supplied to the cathode is reduced by the electrons arriving from the external circuit and combines with the positively charged ions to form water.

H2 FCs may be used as power sources for H2-powered motors of electric vehicles and hybrid electric vehicles, including aircraft. In such applications, the H2 FCs oftentimes are arranged in stacks of multiple cells and connected in a series or parallel arrangement to achieve a desired power and output voltage. H2 FC powered aircraft utilize H2 storage tanks to store H2 needed for powering the FCs, where H2 is transferred to the H2 FCs during operation to thereby power the propulsion system of the aircraft.

To maximize energy density, H2 FC-powered vehicles store H2 as a liquid (e.g. ≤−250° C.) or as a cold gas that must be vaporized and/or conditioned prior to use by the FC. The cold H2 vapor is temperature preconditioned for use by the FC by heating the H2 to a suitable temperature for use, e.g., 80° C. for low-temperature proton exchange membrane (PEM) FCs. Existing temperature conditioning solutions operate by heat exchange between the cold gaseous H2 and either warm air or warm liquid coolant waste stream from the FC stack. However, the suboptimal form factor of current HEs used for this temperature conditioning process makes temperature preconditioning space inefficient and adds weight to an aircraft. The large size of these HEs, along with the additional weight imposed on aircraft, may cause increased drag. Additionally, systems transferring heat between a liquid coolant and gaseous H2 must consider the large pressure differential between the H2 and liquid coolant, as many manufacturing methods may introduce failure points for H2 leakage at interfaces between gas and liquid sides of the HE.

The present disclosure in one aspect provides techniques to manage the size and weight of HEs, integrating a small form factor HE directly onto the surface of existing waste stream pipes. In combination with liquid coolant configurations where the waste stream has far higher heat capacity than the H2, such a design allows for even smaller and more packageable HEs. However, the use of liquid coolant in an H2 HE system requires significant design and manufacture considerations to prevent H2 intrusion and leakage into coolant lines. This poses several unique issues and is a significant failure mode as H2 detection is typically not practicable within the coolant circuit.

To address this problem, in accordance with the present disclosure, temperature preconditioning of H2 is managed by redesigning existing coolant lines on an H2-powered vehicle. More particularly, in accordance with the present disclosure, an HE is integrated onto vehicle coolant piping, thereby minimizing the need for large form factor HEs. This design also eliminates the need for gaskets, joints, or seals between an H2 flow path and the coolant flow path which can fail and result in crossover of H2 into the coolant path. By using such an integrated HE system, potential points of failure due to H2 leaking into the coolant lines are avoided.

Redesigning coolant lines already on the vehicle to temperature precondition H2 avoids additional heavy and complex equipment. The reduced weight and complexity increases safety, range, and payload capacity, and decreases manufacturing and maintenance expenses.

Briefly described, in accordance with Aspect A of the disclosure, there is provided an HE, comprising: an inner pipe or tube configured for receiving a fluid; and an outer tube or jacket surrounding the inner pipe at least in part, and configured to receive a fluid; wherein at least one spiral path is formed around the inner pipe, wherein the at least one spiral path is configured to receive the fluid at an inlet thereof, wherein the fluid is movable along a length of the at least one spiral path, and wherein thermal energy is transferable between the fluid within the inner pipe and the fluid along the at least one spiral path.

In one aspect, a cross-section of the at least one spiral path is rectangular.

In one aspect, a cross-section of the inner pipe or tube is non-circular or rectangular.

In another aspect, the at least one spiral path is integrally formed on the outer surface of the inner pipe.

In a further aspect the at least one spiral path is a helical path.

In still another aspect the at least one spiral path has a fixed pitch across a length of the inner pipe.

In a still further aspect, at least one spiral path has a variable pitch across a length of the inner pipe.

In another aspect the inner pipe has a plurality of spiral paths formed on the outer surface thereof.

In a further aspect the fluid received in the at least one spiral path is a gas, preferably H2 gas, or a liquid.

In still a further aspect, both vaporization and heating of fluid input occur along the length of the at least one spiral path.

In yet another aspect the fluid received in the inner pipe is a liquid.

In a further aspect a linear flow direction of the gas in the at least one spiral path is opposite to a flow direction of the fluid in the inner pipe, or the linear flow direction of the fluid in the at least one spiral path is parallel to a flow direction of the fluid in the inner pipe.

In another aspect a volumetric or mass flow of fluid in the inner pipe is greater than a volumetric or mass flow of fluid in the at least one spiral path, or wherein a heat capacity of fluid in the inner pipe is greater than a heat capacity of fluid in the at least one spiral path.

According to aspect B there is provided a method for exchanging heat in an HE, comprising: providing an HE having an inner pipe or tube having at least one spiral path formed around an outer surface of the inner pipe, and an outer tube or jacket surrounding the inner pipe at least in part; flowing a fluid through the inner pipe; flowing a fluid along the at least one spiral path; and transferring thermal energy of the fluid flowing in the inner pipe to the fluid flowing along the at least one spiral path.

In one aspect the fluid flowing through the at least one spiral path is H2 gas.

In another aspect the fluid flowing through the inner pipe is a liquid.

In a further aspect the fluid flowing through the inner pipe flows in an opposite direction to a linear flow direction of the fluid flowing through the at least one spiral path.

In yet another aspect, a linear flow direction of the fluid in the at least one spiral path is parallel to a flow direction of the fluid in the inner pipe.

According to aspect C there is provided a system for gas-liquid heat exchange in an H2 FC-powered vehicle comprising: at least one FC configured to power the vehicle; a fuel tank configured to contain liquid H2 or cold gaseous H2 fuel for the FC; and an HE configured to heat the liquid H2 or the cold gaseous HE H2 to an operating temperature for the FC, wherein the HE comprises an H2 HE having an inner pipe or tube configured for receiving a fluid, wherein the inner pipe or tube has at least one spiral path formed around an outer surface of the inner pipe, and an outer tube or jacket surrounding the inner pipe at least in part, wherein the at least one spiral path is configured to receive the liquid H2 or the cold gaseous H2 at an inlet thereof, wherein the liquid H2 or the gaseous H2 is movable along a length of the at least one spiral path, whereupon thermal energy of the fluid within the inner pipe is transferrable to the liquid H2 or the gaseous H2 along the spiral path.

In one aspect the at least one spiral path is integrally formed on the outer surface of the inner pipe.

In another aspect the fluid is a warm waste fluid used to cool or regulate a system or component on the vehicle, or to cool or regulate a temperature of an occupant cabin on the vehicle.

In a further aspect the vehicle is an aircraft.

In yet another aspect the warm waste liquid fluid is used to cool or regulate a temperature of a system component on the aircraft, or to cool or regulate an occupant cabin on the aircraft.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Further features and advantages of the disclosure will be seen in the following detailed description, taken in conjunction with the accompanying drawings, wherein like numerals depict like parts. The drawings described herein are for illustrative purposes only of selected embodiments and not all possible implementations and are not intended to limit the scope of the present disclosure.

In the drawings:

FIG. 1 is a diagrammatic cross-section view of an HE, in accordance with the present disclosure.

FIG. 2 is a cross-section illustration of an HE, in accordance with the present disclosure.

FIG. 3 is a diagrammatic illustration of an HE, in accordance with the present disclosure.

FIG. 4 is a perspective view illustration of an HE, in accordance with the present disclosure.

FIG. 5 is a partial cross-section illustration of an HE with variable pitch, in accordance with the present disclosure.

FIG. 6 is a graphical image of temperature in an HE configured for heating H2 gas, in accordance with the present disclosure.

FIG. 7 is a graph illustrating heat exchange in an HE configured for H2 as a function of H2 input temperature.

FIG. 8 is a diagrammatic illustration of a power train portion of a vehicle using the HE configured for H2, in accordance with the present disclosure.

FIG. 9 is a flowchart illustrating an exemplary sequence of operations of the method for exchanging heat in an HE, in accordance with the present disclosure.

FIG. 10 is a schematic depiction of a H2 FC powered aircraft in accordance with the present disclosure.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, components, and/or groups, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, and/or sections, these elements, components, regions, layers, and/or sections should not be limited by these terms. These terms may be only used to distinguish one element, component, region, layer or section from another element, component, region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Also, as used herein the terms “pipe” and “tube”, and “pipe”, “tube” and “jacket” are used interchangeably.

And as used herein the terms “coolant” and “liquid coolant”, which are used to describe the fluid flowed through the inner pipe or tube of the HE, comprises gas or liquid coolant from coolant lines already on the vehicle for cooling other components of the vehicle and/or the passenger and/or crew cabins. As so described the coolant actually is significantly warmer than the gaseous H2 which is flowed in the space between the inner and outer tube or pipe of the HE, and gives up or transfers thermal energy to the gaseous H2 to warm the H2 to a desired operation temperature for introduction into the FC.

As mentioned previously, conventional techniques for preconditioning H2 using HEs adds expense, weight, and complexity to the operation of a vehicle, all while decreasing the payload capacity. The present disclosure addresses these shortcomings by using and redesigning existing coolant lines on the vehicle for preconditioning gaseous H2 using HEs configured such that the gaseous H2 flows in a spiral path around the inner tube. For example, a coolant pipe may be designed with a spiral gas path directly integrated to an outer surface of the coolant pipe. In this arrangement, a spiral gas path for H2 gas may be integrated onto the outer surface of the coolant pipe to perform liquid-gas heat exchange. This design eliminates H2 leakage paths into the coolant line. The spiral arrangement of a gas path for the gaseous H2 around the coolant pipe also permits control of pressure, flow velocity, and thus heat transfer coefficient within the H2 gas flow path. A similar gaseous flow geometry may be applied to high temperature FC stacks (HTPEM) to perform gaseous heat exchange with the HTPEM coolant or exhaust air streams.

This technique and design can be used to perform heat transfer to temperature precondition H2 fuel for use by a FC over a short HE length. Furthermore, this H2 HE can be positioned or located in areas that are otherwise solely used for pipework. This arrangement enables more space efficient packaging of FCs and HEs.

The improvements disclosed herein can be realized as an HE used to precondition H2 for use by a FC in a vehicle powered by at least one FC. The vehicle may be, for instance, an aircraft which is powered by an H2 FC. In other examples, the vehicle may include any land, water, or air-based vehicle, or combination thereof, which is operated manually, autonomously, or semi-autonomously, and which is powered by FCs deriving energy from any type of source. The vehicle has a coolant pipe that is configured for receiving liquid coolant and at least one H2 gas path, which may be a spiral path, positioned around an outer surface of the coolant pipe. The at least one H2 gas path is configured to receive H2 gas at an inlet thereof. H2 is movable along a length of the at least one H2 gas path, and thermal energy of liquid coolant within the coolant pipe is transferred to H2 gas within the H2 gas path.

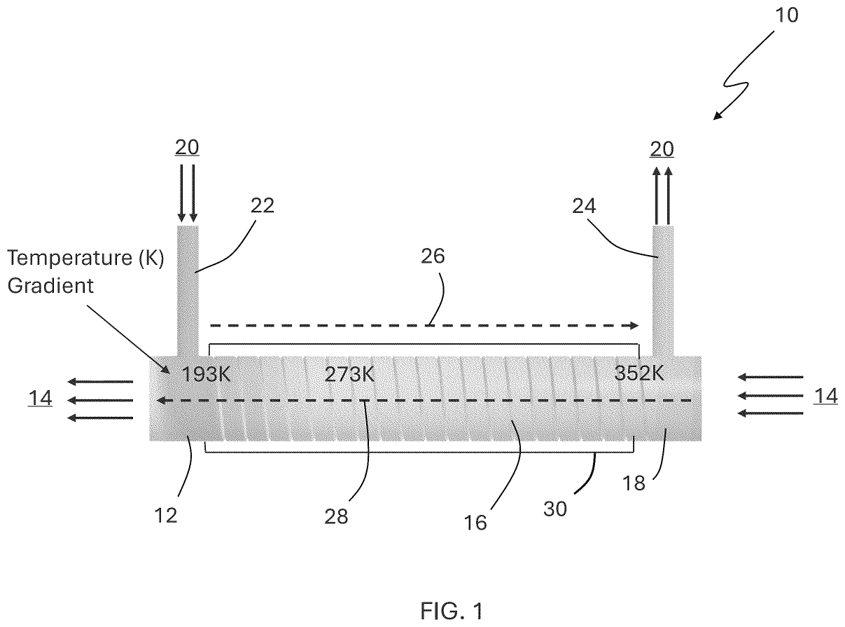

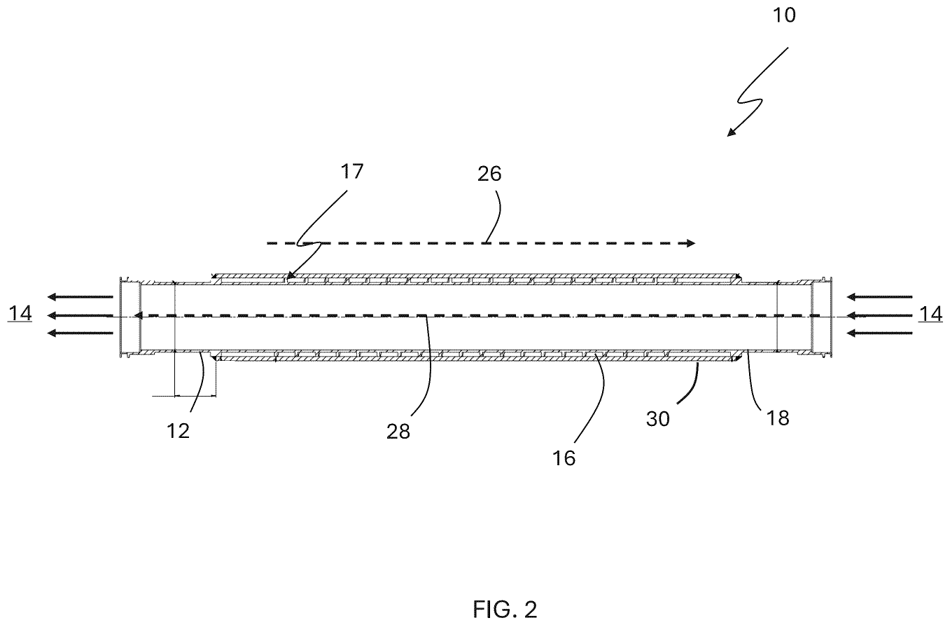

FIG. 1 is a diagrammatic view of an H2 HE 10, in partial cross-section, for use on a vehicle in accordance with the present disclosure, and FIG. 2 is a cross-section illustration of the H2 HE 10 of FIG. 1 in accordance with the present disclosure. With reference to FIGS. 1-2, the H2 HE 10 has an inner tube or pipe 12 that is configured for receiving a fluid 14 from coolant lines (not shown) already on the vehicle, and an outer tube or pipe 30 surrounding the inner tube or pipe 12, at least in part. At least one spiral path 16 is formed around an outer surface 18 of the inner pipe 12. The at least one spiral path 16 is configured to receive gas 20 at an inlet 22 thereof. The gas 20 is movable along a length 26 of the at least one spiral path 16 in a direction opposite to the flow direction of the fluid 14, whereupon thermal energy of the fluid 14 within the inner pipe 12 is transferred to the gas 20 travelling along the spiral path 16.

Fluid 14 within inner pipe 12 is configured to travel in a linear direction aligned with a flow path 28, but preferably in a linear direction opposite to the linear direction of gas 20. Gas 20 is introduced into spiral path 16 through inlet 22, whereby the H2 gas 20 travels along spiral path 16, which wraps around or spirals around outer surface 18 of inner pipe 12. In totality, H2 gas 20 moves along a linear flow path 26 and exits through an outlet 24 of spiral path 16. The H2 HE 10 is configured as a counterflow HE, where linear flow path 26 of H2 gas 20 through spiral path 16 is in a direction that opposes the linear flow path 28 of fluid 14 in inner pipe 12. These opposing flow paths 26, 28 facilitate thermal energy or heat transfer between fluid 14 within the inner pipe 12 and gaseous H2 20 within spiral path 16. For example, fluid 14 enters the inner pipe 12 at a first end, and travels right to left. Fluid 14 entering the inner pipe 12 is a temperature that is warmer than the gaseous H2 20 flowing along spiral path 16. Thus, gaseous H2 20 entering the spiral path 16 from inlet 22 travels in a left to right linear direction. This arrangement, where fluid 14 and gaseous H2 20 travel in opposite directions, distributes thermal energy more evenly across the H2 HE 10.

In another example, linear flow path 26 of H2 gas 20 in spiral path 16 may be parallel with the flow path 28 of fluid 14 in the inner pipe 12. In this example, H2 gas 20 and fluid 14 travel in the same direction as each other. In this arrangement, thermal energy may distribute to the extent that the temperature of H2 gas 20 exiting from the outlet 24 will remain cooler than or be the same temperature as fluid 14 exiting the inner pipe 12. In embodiments where the coolant is a liquid, the coolant may undergo very little temperature change across the length of the HE such that a parallel flow configuration has a minimal impact on performance.

In one example, spiral path 16 may be integrally formed into the outer surface 18 of the inner pipe 12. In other words, spiral path 16 may be formed by machining the outer surface 18 of the inner pipe 12 to form a helical or spiral structure that spirally or helically extends along the length of inner pipe 12. By bonding an outer tube over this machined spiral structure, an enclosed spiral gas flow path 16 is then formed. In some embodiments, only a fraction of or none of the sidewalls 17 are bonded to the outer tube or jacket 30. This construction permits some fluid leakage between the sidewalls 17 and outer jacket 30, but further improves manufacturability without significant performance degradation for many embodiments. Spiral path 16 may be made through other manufacturing methods, such as 5-axis machining, casting, additive manufacturing, or extrusion. In another example, the spiral path 16 may be formed around the inner pipe 12 by welding, adhering, bolting, or epoxying a wire or a length of a material around outer surface 18 of the inner pipe 12. In this example, the material may be wrapped around the outer surface 18 of the inner pipe 12 to form a spiral structure, where the channels or grooves of the spiral forms spiral path 16. Spiral path 16 also may be formed by additive manufacturing, where a suitable material such as aluminum or other metal may be extruded or deposited in layers to directly build the spiral path 16 as an internal feature to the pipe. Alternatively, additive manufacturing may also build layers onto the outer surface 18 of a preexisting inner pipe 12 to form a spiral structure.

In manufacturing of the H2 HE 10, the spiral path 16 is formed integral to, or on the outer surface of inner pipe 12 such that there is a barrier between the spiral path 16 and inner pipe 12. In other embodiments, the spiral path 16 may be formed on the inner surface of the outer tube 30, allowing for minimal modification to previously designed coolant pipe systems. By assembling the spiral path 16 using either the outer surface of inner pipe 12 or inner surface of tube 30, manufacturing complexity and cost is minimized. Such embodiments require no directly machined internal channels, as the spiral paths 16 are exposed for direct tooling access until the inner and outer pipes are bonded together. In these embodiments, no machining ever creates a new opening in inner tube 12, eliminating the introduction of any fluid ingress points due to manufacturing errors. This also reduces the need to implement sealing measures between the two structures and removes the corresponding inspection steps during manufacturing, reducing part costs.

FIG. 2 depicts the outer surface 18 of the inner pipe 12 acting as the barrier with the spiral path 16, where each path, channel, conduit, or groove of the spiral path 16 has a rectangular cross-section. The rectangular shape of the cross-section of spiral path 16 increases the surface area of spiral path 16, and its dimensions may be modified to control the velocity, and thus convective heat transfer coefficient, of the fluid flowing through spiral path 16. This optimization enables a greater amount of thermal energy to be conducted between the contents of inner pipe 12 and the contents of spiral path 16, such as H2 gas 20. Controlling the relative flow area of the fluid in inner pipe 12 and the fluid along spiral path 16 is also relevant to HE performance, and in some embodiments it may be ideal for the inner pipe 12 to have a flow area similar to adjoining pipes, on the order of 18 cm² compared to a spiral path 16 flow area on the order of 0.5 cm². Without a spiral path 16 constraining fluid flow, achieving such a flow area for the fluid in the outer path would require a very narrow, difficult to machine radial gap between the inner and outer tubes of the heat exchanger. With the spiral path 16 feature, however, the radial gap may be much larger, enabling low-cost part manufacture.

FIG. 2 also illustrates the overall difference in size between the spiral path 16 and inner pipe 12. This difference in size results in a difference of volumetric flow of H2 gas 20 within spiral path 16 relative to the volumetric flow of fluid 14 within the inner pipe 12. The volumetric flow of fluid 14 within the inner pipe 12 is significantly greater than the volumetric flow of H2 gas 20 within the spiral path 16. This may also be described in terms of mass flow, where fluid 14 in the inner pipe 12 has high mass flow relative to H2 gas 20 in the spiral path 16, which has a low mass flow. This arrangement reduces the risk of localized freezing of fluid 14 in inner pipe 12 as H2 gas 20 passes through spiral path 16 as thermal energy is transferred from fluid 14. Because of this difference in volumetric flow or mass flow, and the heat capacity of fluid 14, fluid 14 temperature may only have small changes as compared to H2 gas 20, which may experience more drastic temperature changes. For example, the temperature of fluid 14 may only decrease 1-2° C. as H2 gas 20 temperature increases by 80-120° C. The geometry of the inner pipe 12 may also aid in ensuring consistent flow such that fluid 14 does not stagnate, thus limiting situations where fluid 14 may undergo localized freezing. In other embodiments, such as HTPEM FCs, where both the fluid in the inner pipe 12 and fluid in the spiral path 16 are gases, the coolant may experience a larger change in temperature across the HE. However, the higher waste stream temperature, larger volume flow within the inner pipe, and simple HE geometry within the inner pipe all contribute to preventing localized stagnation or freezing.

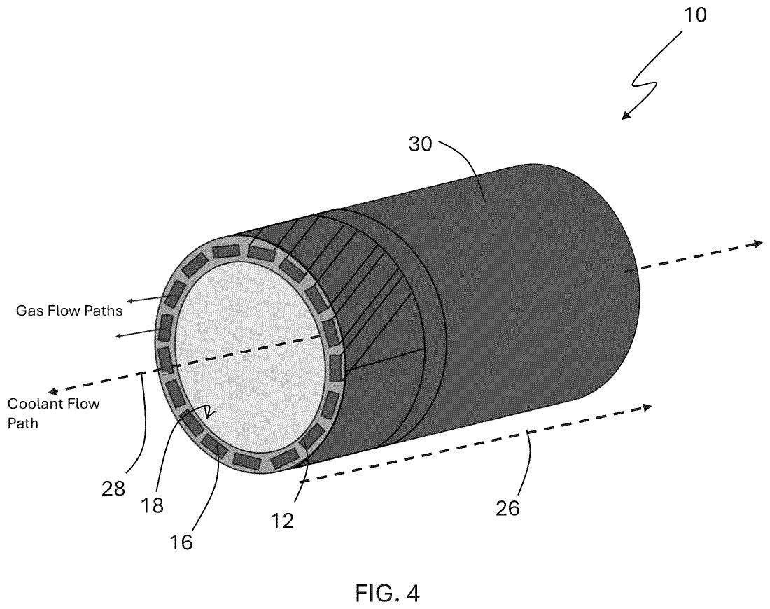

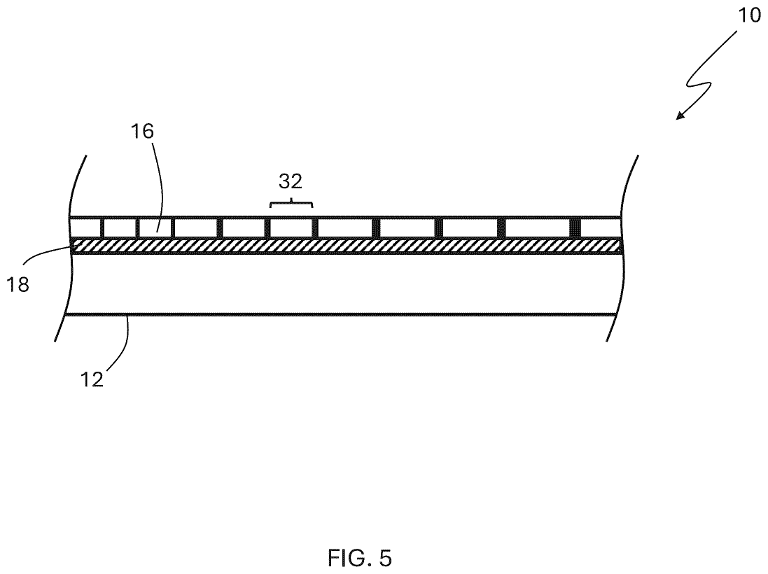

FIG. 2 depicts spiral path 16 in a helical formation to create a helical path. Accordingly, spiral path 16 is understood to include a helix as well as another path or conduit that may increase or decrease in radii as it spirals around the inner pipe 12. This is particularly useful in implementations where the inner pipe 12 has a variable radius. For example, as the radius of inner pipe 12 increases or decreases, the radii of spiral path 16 may also increase or decrease. Additionally, spiral path 16 is understood to include implementations with variable pitch, as shown in FIG. 5. Spiral path 16 may also be a helical path as shown in FIG. 2. A helical path is a subset of spiral paths 16 with a constant radius. This is seen in examples where inner pipe 12 has a constant radius along an entirety of the length of the flow path 28. Further aspects and details of the helical and spiral path 16 are described relative to FIGS. 4 and 5. FIG. 2 contains several of the same structures and components as described relative to FIG. 1, which are not restated for brevity in disclosure.

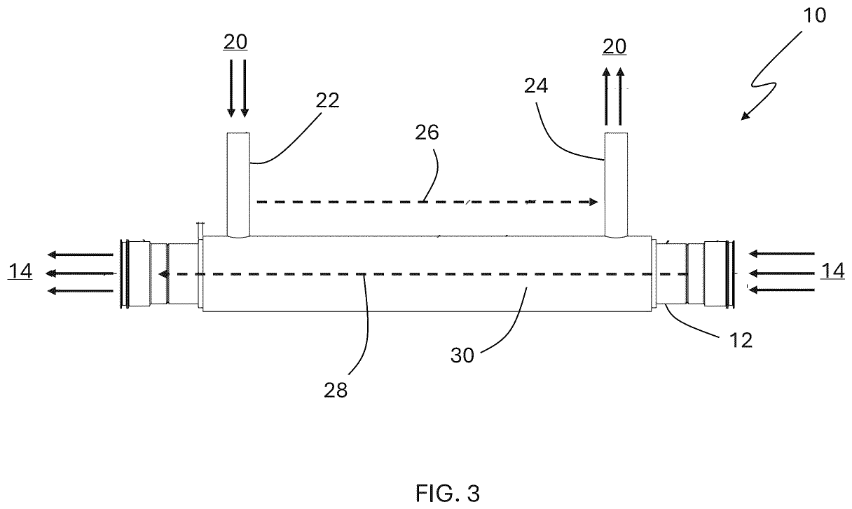

FIG. 3 is a diagrammatic illustration of the H2 HE 10, in accordance with the present disclosure. In particular, FIG. 3 illustrates an H2 HE 10 where the spiral path 16 is covered by an outer annular jacket 30. In some embodiments, the outer annular jacket 30 may consist of a pipe or tube with an inner radius sufficiently larger than the outer radius 18 of the inner pipe. The outer annular jacket 30 creates a closed path for the spiral path 16 by enclosing the interior sections of the spiral path 16, such as where outer annular jacket 30 is sealed against sidewalls 17 forming the spiral path 16. In some embodiments, the outer annular jacket 30 is not sealed against path sidewalls 17 allowing some fluid flow over the outer edge of the spiral path. Because the connection between the sidewalls 17 of the spiral path 16 and outer surface 18 of the inner pipe 12 is formed through an integral gasket-free connection, unintended H2 gas 20 leakage from the spiral path 16 and/or mixing of the H2 gas and the fluid in the inner pipe 12 is prevented. This is also true for examples where the spiral path 16 is formed on top of and around the outer surface 18 of inner pipe 12 by additive manufacturing or by welding. This design and manufacturing method maintains a solid barrier between the spiral path 16 and inner pipe 12 such that no leakage of H2 gas 20 into fluid 14 can occur.

Manufacturing the H2 HE 10 by using the outer annular pipe, tube or jacket 30 simplifies manufacturing and/or maintenance of the H2 HE, as spiral path 16 can be formed around the outer surface 18 of inner pipe 12 and subsequently covered by the outer annular tube or jacket 30. The outer annular tube or jacket 30 may be slid over the outer surface 18 of inner pipe 12, welded to the inner pipe 12.

FIG. 4 is a perspective view illustration of the H2 HE 10, in accordance with the present disclosure. More particularly, FIG. 4 illustrates a plurality of spiral paths 16 positioned along the outer surface 18 of inner pipe 12, a feature of some additively manufactured embodiments. In this example, several spiral paths 16 may be used to further increase surface area where H2 gas 20 or another fluid can conduct thermal energy to or from fluid 14 or another fluid inside of inner pipe 12.

FIG. 5. is a cross-sectional illustration of the H2 HE 10 configured with a variable pitch 32 of spiral path 16. By altering the cross-sectional area of the flow path, embodiments with this design allow for localized control of heat transfer coefficient, gas velocity, and pressure. In some embodiments, variable pitch is used across the length of spiral path 16 to account for the density decrease as a fluid, such as gaseous H2, warms. Pitch may increase in step(s) or continuously from inlet 22 towards outlet 24 to preserve the desired fluid velocity.

In other exemplary embodiments, the variable pitch design is utilized to facilitate a liquid phase fluid input, such as LH2. These embodiments allow the heat exchanger to perform both H2 vaporization and H2 preconditioning for LH2-based FC systems. H2 undergoes a significant density and pressure change as it heats and changes phases from LH2 to GH2, and an increase in pitch 32 is made within a region or across the entire spiral path length to maintain the desired density, pressure, and flow velocity. The combination of both vaporization and preconditioning functionalities into one highly packageable heat exchanger can significantly reduce the weight and footprint required to prepare LH2 fuel for use in a FC stack, yielding further vehicle efficiency improvements. Additionally, conventional vacuum jacketing methods for cryogenic systems may be applied to embodiments as necessary due to the tubular geometry of the HE.

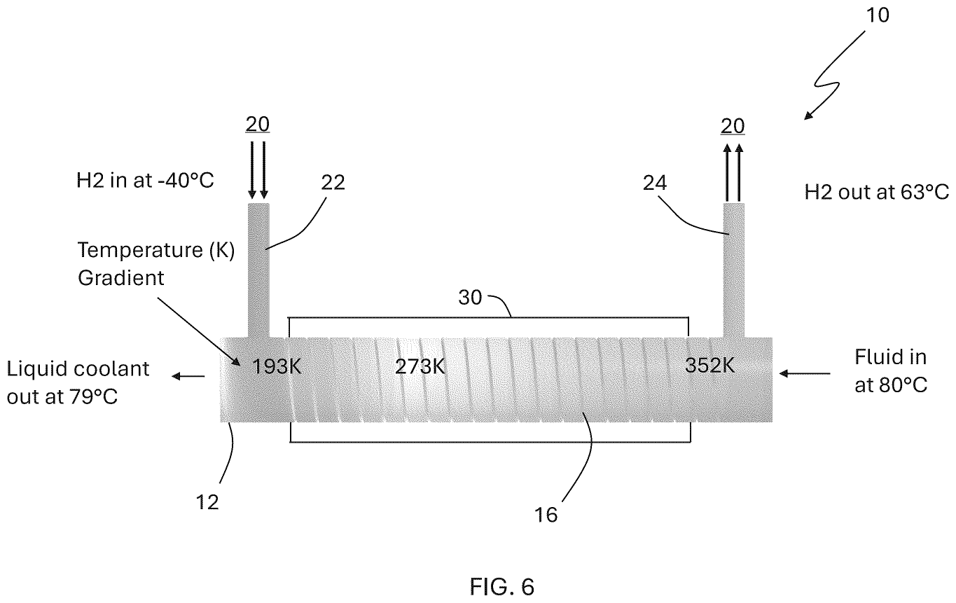

FIG. 6 is a graphical image of temperature in a H2 HE 10, in accordance with the present disclosure, which depicts the change in temperature of the fluid 14 and the gaseous H2 along the length of an exemplary H2 HE 10 system in accordance with the present disclosure. The example system is modeled with a fluid flow rate of approximately 10kg/s which enters the heat exchanger at 80° C., and an H2 flow rate of approximately 3g/s which enters the heat exchanger at −40° C.

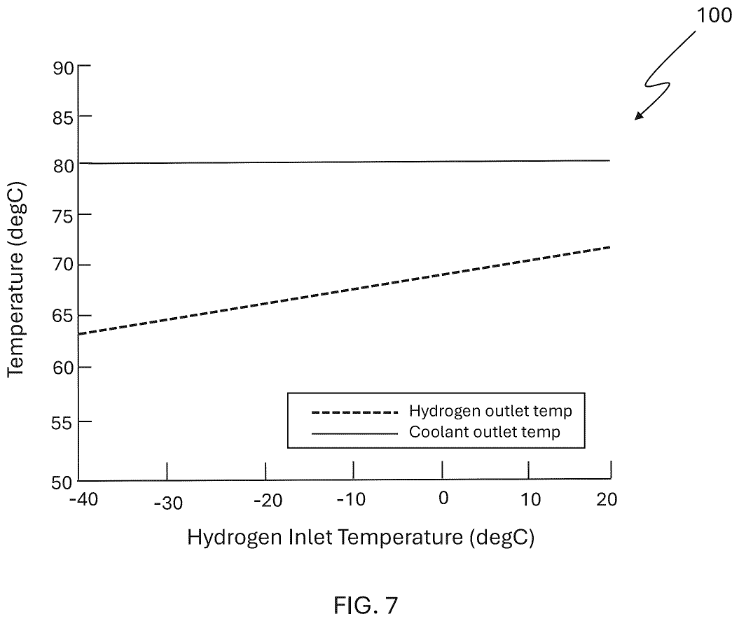

FIG. 7 is a graph 100 illustrating heat exchange as a function of H2 input temperature in an FC aviation system employing the H2 HE of FIG. 1. As can be seen, the outlet or exit temperature of the fluid remains steady across increasing H2 gas inlet temperatures. Conversely, H2 gas outlet temperature increases in a linear relation to H2 gas inlet temperature. The example system is modeled with a coolant flow rate of approximately 10 kg/s which enters the heat exchanger at 80 C, and an H2 flow rate of approximately 3 g/s. For this exemplary system, these trends arise due to the coolant mass flow being very high in comparison to the H2 flow rate, as expected in a gas/liquid configuration of this HE. These curves are expected to vary between embodiments, with variables such as choice of fluids, phase of fluids, and geometry of spiral path 16 impacting resulting values and trends.

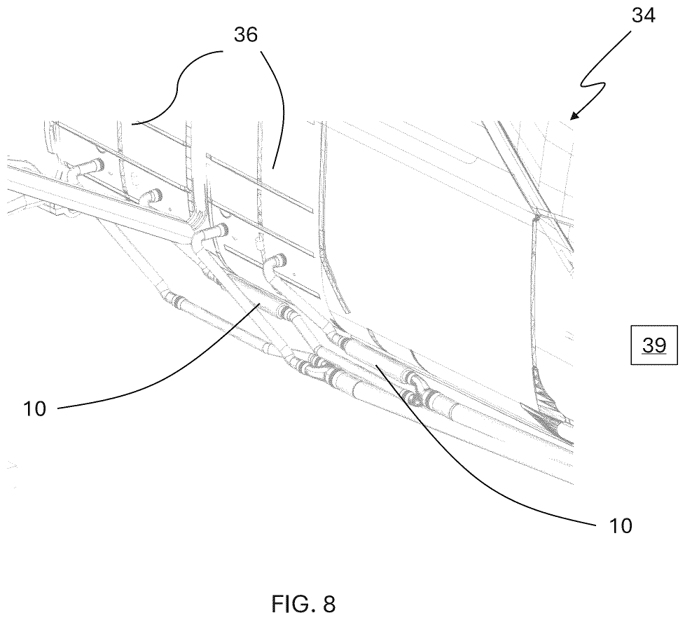

FIG. 8 is a diagrammatic illustration of a power train portion of a FC 36 powered vehicle 34 using the H2 HE 10, in accordance with the present disclosure. Because of the small form factor of the H2 HE 10, the H2 HE 10 can easily be implemented and installed into a vehicle 34, which may be an aircraft and connected to the fluid and H2 lines of one or more FCs 36. In one example, the fluid used by the H2 HE 10 may be warm waste fluid that is used to cool or regulate other systems or components such as the cabin(s) 39 of the vehicle 34. The temperature of the warm waste fluid before entering the H2 HE 10 is a temperature that is greater than the temperature of H2 gas entering the H2 HE 10.

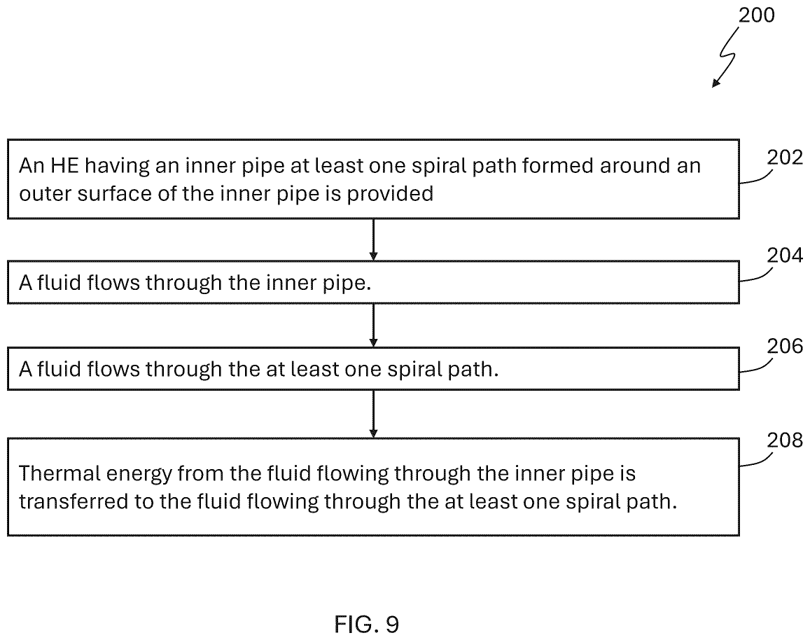

FIG. 9 is a flowchart 200 illustrating an exemplary sequence of operations of the method for exchanging heat in the H2 HE, in accordance with the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As shown by block 202, an inner pipe and at least one spiral path integrally formed around an outer surface of the inner pipe is provided. A fluid flows through the inner pipe (block 204). A fluid gas, or possibly a liquid in the variable pitch embodiment, flows through the at least one spiral path (block 206). Thermal energy from the fluid flowing through the inner pipe is transferred to the fluid flowing through the at least one spiral path (block 208).

Any number of additional steps, functions, processes, or variants thereof may be included in the method, including any disclosed relative to any other figure of this disclosure. For instance, flowing H2 gas through the at least one spiral path and flowing a fluid through the inner pipe. The method may also further include increasing a volumetric flow of gas through the spiral path by increasing a pitch of the at least one spiral path. The method may also further include using a plurality of spiral paths, where each of the spiral paths of the plurality of spiral paths are integrally formed around an outer surface of the inner pipe to increase a transfer of thermal energy.

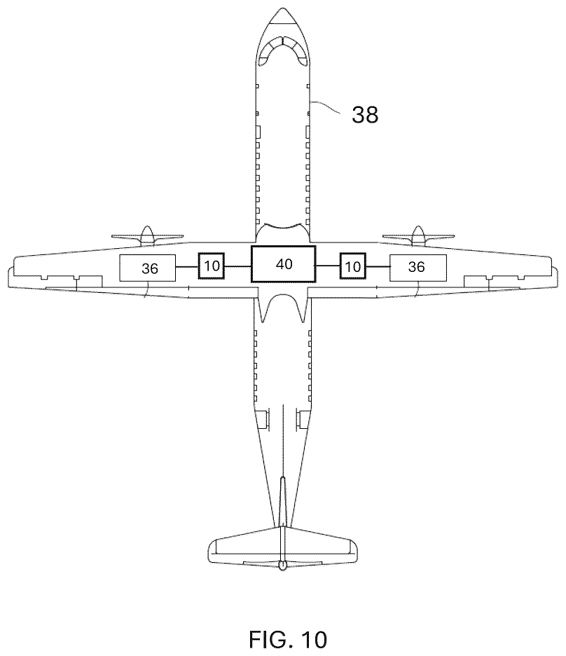

FIG. 10 illustrates an FC 36 powered aircraft 38 in accordance with the present disclosure, and including one or more H2 fuel tanks 40 configured to hold liquid or cold gaseous H2, and including an H2 HE 10 for vaporizing the liquid H2 and heating the gaseous H2 to a desirable operative temperature for feeding to the FCs 36.

The systems, methods, and techniques described herein indicate that conventional bulky, additional hardware, or systems using gaskets and seals between H2 gas lines and fluid lines are not needed for temperature conditioning of H2 for use by FCs. Redesigning fluid pipes already on the vehicle to temperature precondition H2 through HEs avoids additional heavy and complex equipment. The reduced weight and complexity act to increase safety, range, and payload capacity, and they decrease manufacturing and maintenance expenses.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Various changes and advantages may be made in the above disclosure without departing from the spirit and scope thereof.

### LIST OF REFERENCES

10 H2 HE
12 inner pipe
14 fluid
16 spiral path
17 sidewall
18 outer surface
20 gas
22 inlet
24 outlet
26 linear flow direction
28 flow direction
30 jacket
32 pitch
34 hydrogen powered vehicle
36 fuel cell
38 aircraft
39 cabin(s)
40 fuel tank

What is claimed is:

1. A heat exchanger (HE), comprising:
an inner pipe or tube configured for receiving a fluid; and
an outer tube or jacket surrounding the inner pipe at least in part, and configured to receive a fluid;
wherein at least one spiral path is formed around the inner pipe, wherein the at least one spiral path is configured to receive the fluid at an inlet thereof, wherein the fluid is movable along a length of the at least one spiral path, and wherein thermal energy is transferrable between the fluid within the inner pipe and the fluid along the at least one spiral path.

2. The HE of claim 1, wherein a cross-section of the at least one spiral path is rectangular.

3. The HE of claim 1, wherein the cross-section of the inner pipe or tube is non-circular or rectangular.

4. The HE of claim 1, wherein the at least one spiral path is integrally formed on the outer surface of the inner pipe.

5. The HE of claim 1, wherein the at least one spiral path is a helical path.

6. The HE of claim 1, wherein the at least one spiral path has a fixed pitch across a length of the inner pipe, or wherein the at least one spiral path has a variable pitch across a length of the inner pipe.

7. The HE of claim 1, wherein the inner pipe has a plurality of spiral paths formed on the outer surface thereof.

8. The HE of claim 1, wherein the fluid received in the at least one spiral path is a gas, preferably hydrogen (H2) gas, or a liquid.

9. The HE of claim 1, wherein both vaporization and heating of a fluid input occur along the length of the at least one spiral path.

10. The HE of claim 1, wherein the fluid received in the inner pipe is a liquid.

11. The HE of claim 1, wherein a linear flow direction of the fluid in the at least one spiral path is opposite to a flow direction of the fluid in the inner pipe, or the linear flow direction of the fluid in the at least one spiral path is parallel to a flow direction of the fluid in the inner pipe.

12. The HE of claim 1, wherein a volumetric or mass flow of fluid in the inner pipe is greater than a volumetric or mass flow of fluid in the at least one spiral path, or a heat capacity of fluid in the inner pipe is far greater than a heat capacity of fluid in the at least one spiral path.

13. A method for exchanging heat in a heat exchanger (HE), comprising:
providing an HE having inner pipe or tube having at least one spiral path formed around an outer surface of the inner pipe, and an outer tube or jacket surrounding the inner pipe at least in part;
flowing a fluid through the inner pipe;
flowing a fluid along the at least one spiral path; and
transferring thermal energy of the fluid flowing in the inner pipe to the fluid flowing along the at least one spiral path.

14. The method of claim 12, wherein the fluid flowing through the at least one spiral path is hydrogen (H2) gas.

15. The method of claim 12, wherein the fluid flowing through the inner pipe is a liquid.

16. The method of claim 12, wherein the fluid flowing through the inner pipe flows in an opposite direction to a linear flow direction of the fluid flowing through the at least one spiral path.

17. The HE of claim 1, wherein a linear flow direction of the fluid in the at least one spiral path is parallel to a flow direction of the fluid in the inner pipe.

18. A system for gas-liquid heat exchange in a hydrogen fuel cell (H2 FC) powered vehicle, preferably an aircraft, comprising:
at least one FC configured to power the vehicle;
a fuel tank configured to contain liquid H2 or cold gaseous H2 fuel for the FC; and
a heat exchanger (HE) configured to heat the liquid H2 or cold gaseous H2 to an operating temperature for the FC, wherein the HE comprises an H2 HE having an inner pipe or tube configured for receiving a fluid, wherein the inner pipe or tube has at least one spiral path formed around an outer surface of the inner pipe, and an outer tube or jacket surrounding the inner pipe at least in part, wherein the at least one spiral path is configured to receive the liquid H2 or the cold gaseous H2 at an inlet thereof, wherein the liquid H2 or the gaseous H2 is movable along a length of the at least one spiral path, whereupon thermal energy of the fluid within the inner pipe is transferrable to the gaseous H2 along the spiral path.

19. The system of claim 18, wherein the at least one spiral path is integrally formed on the outer surface of the inner pipe.

20. The system of claim 18, wherein the fluid is a warm waste fluid used to cool or separate a system or component on the vehicle, or to cool or regulate a temperature of an occupant cabin on the aircraft.
